(19) United States
(12) Patent Application Publication
(10) Pub. No.: US 2015/0291429 A1
(43) Pub. Date: Oct. 15, 2015

(54) METHOD FOR TREATING SINGLE WALL CARBON NANOTUBE

(71) Applicants: Guanglu GE, Beijing (CN); Lirong WANG, Beijing (CN); Xue XUE, Beijing (CN); Xingjie LIANG, Beijing (CN); National Center for Nanoscience and Technology, Beijing (CN)

(72) Inventors: Guanglu Ge, Beijing (CN); Lirong Wang, Beijing (CN); Xue Xue, Beijing (CN); Xingjie Liang, Beijing (CN)

(73) Assignee: NATIONAL CENTER FOR NANOSCIENCE AND TECHNOLOGY, Beijing (CN)

(21) Appl. No.: 14/417,637

(22) PCT Filed: Jul. 27, 2012
(86) PCT No.: PCT/CN2012/079248

§ 371 Date: Jun. 26, 2015

(51) Int. Cl. C01B 31/02; B01D 21/26

(52) U.S. Cl. CPC C01B 31/0266; B01D 21/262; C01B 2202/02; Y10S 977/845; B82Y 40/00

(57) ABSTRACT

Provided is a method for treating single-walled carbon nanotube, comprising: (1) allowing single-walled carbon nanotubes to contact with a surfactant and a dispersant sequentially in the present of a solvent, to obtain highly dispersed single-walled carbon nanotubes in which the content of single dispersed single-walled carbon nanotubes is not lower than 50 wt %, wherein, the single-walled carbon nanotubes can be dispersed in the solvent, and the surfactant and dispersant can be dissolved in the solvent; (2) employing density gradient centrifugation to sort the highly dispersed single-walled carbon nanotubes obtained in step (1). This method can effectively separate single-walled carbon nanotubes with different structural properties.

### FIELD OF THE INVENTION

The present invention relates to a method for treating single wall carbon nanotube.

### BACKGROUND OF THE INVENTION

As a unique nano-material in one-dimensional tubular molecular structure with radial dimension at nano-level and axial dimension up to micro-level, carbon nanotubes are of a one-dimensional quantum material with typical laminar hollow structure characteristic and composed of hexagonal carboncyclic structural units. Wherein, single-walled carbon nanotubes (SWNTs) are composed of a single cylindrical graphite layer, and have narrower diameter distribution range, less defects, and higher uniformity when compared with multi-walled carbon nanotubes (MWNTs). SWNTs have not only low density and favorable electrical properties but also high thermal and chemical stability, etc., owing to their unique structure. In the biological field, SWNTs are ideal carriers for nano-drugs, owing to their unique one-dimensional nanometer structure. Studies have revealed that carbon nanotube composite materials can provide skeleton and bearer for new muscle, and can induce directional differentiation of bone cells, and can be used as a multi-functional biological transmitter and a medium for selectively killing cancer cells under near infrared ray.

In recent years, researches on the biological effects of carbon nanotubes showed that the diversity of preparation methods and structural properties of carbon nanotubes brought many difficulties, wherein, the purity, dimensions, and aggregation level of carbon nanotubes, etc. may have influences on the cellular behaviors. Becker et al prepared a stable dispersed solution system with DNA-wrapped carbon nanotubes, in which the electronic structure on the surfaces of carbon nanotubes was kept, and studied the variations in dimensions of carbon nanotubes when the carbon nanotubes are taken by cells. The research indicated that the cell uptake of carbon nanotubes has length selectivity and all carbon nanotubes in length smaller than 180±17 nm usually can be taken by cells. The research made by Simon et al indicated that both long MWNTs and short MWNTs have strong cytotoxicity. Smart et al believe that the toxic and side effects of carbon nanotubes may be resulted from the metallic catalyst used in the preparation process, but chemical modification can not only effectively remove residual metallic catalyst but also introduce bioactive molecules, and thereby can improve the biocompatibility of carbon nanotubes. The research made by Sayes et al indicated: as the functionalization level of side walls of SWNTs is increased, the cytotoxicity will be reduced. Dumortier et al believe that ftmctionalized SWNTs have no significant effect to the functions of immunological cells. An important factor that results in significant difference in relevant present researches is: the subject studied is a mixture of SWNTs that are obtained from different sources or by different functionalization patterns and have different structural properties. Current research findings are not comparable with each other, because the researches oriented to the fractions of SWNTs with different structural properties (e.g., diameter, aggregation, and length, etc.) in the same system are inadequate. Therefore, it is unable to interpret the biological effect difference and mechanism of SWNTs based on the structural properties of SWNTs. Thus it can be seen that in order to obtain comprehensive and in-depth understanding of the influences of carbon nanotubes on environment and health, the biological effect and toxicity mechanism of carbon nanotubes must be studied systematically from different aspects, including synthetic method, particle size, surface properties and shape, etc. Thus, to solve the problems, one of the key factors is to prepare in bulk SWNTs fractions that are from the same source but have different structural properties, and it is of crucial importance to build up a targeted SWNTs separation system.

Viewed from recent researches, because carbon nanotubes have different physico-chemical and biological properties, a systematic study of carbon nanotubes with different structural properties will be crucial. As described above, how to accomplish bulk preparation and separation of carbon nanotubes with different structural properties will be a key point in relevant researches. Recently, researches have demonstrated that the separation and preparation of carbon nanotubes has drawn more and more attention. And Research on the separation of carbon nanotubes according to their structural properties is especially important, and is a key of the present study. Common separation methods include dielectrophoresis, chromatography, and selective growth methods, etc., but all of them have their limitations. For example, dielectrophoresis is mainly for separation of semiconductor and conductive carbon nanotubes, and has a narrow application range; chromatography requires complex preliminary treatment and has high requirements for samples; the separating effect of selective growth method is affected by factors such as carbon nanotube functionalization, sample pretreatment and recovery, the instrument and equipment and yield, etc., and thereby the subsequent application of selective growth method is limited. However, it is noteworthy that a density gradient centrifugation has become an important method for separation of carbon nanotubes recently. Though this method was applied late in the application field of carbon nanotube separation, it has become a hotspot in the carbon nanotube separation field gradually because the operating process is simple and controllable. Arnold et al pioneered to utilize density gradient centrifugation and mixed surface dispersant to separate carbon nanotubes with different electrical properties or different tube diameters. However, owing to the existence of a large quantity of aggregated tube bundles in carbon nanotubes, the effective strips are blur and the proportion is very low, and thus the ultimate separating effect and yield are severely limited. Dai et al carried out separation of ultra-short SWNTs by length with the density gradient centrifugation technique. However, owing to the particularity in sample size, the structural properties are somewhat different from those of one-dimensional carbon nanotubes, and this method is not suitable for wide application. Weisman et al pioneered to utilize density gradient centrifugation technique to carry out chiral separation of SWNTs. However, owing to the existence of a large quantity of aggregated tube bundles, the separation yield is severely limited, and the separation product is impractical to apply. Therefore, how to improve the single-dispersity of carbon nanotubes and decrease the proportion of aggregated carbon nanotube bundles is a key for improving the gradient centrifugation separation yield.

### SUMMARY OF THE INVENTION

To overcome the above-mentioned drawbacks in the prior art, the present invention provides a method for treating single-walled carbon nanotubes, which can be used to separate single-walled carbon nanotubes according to different structural properties.

The present invention provides a method for treating single-walled carbon nanotubes, comprising the following steps:
(1) allowing single-walled carbon nanotubes to contact with a surfactant and a dispersant sequentially in the present of a solvent, to obtain highly dispersed single-walled carbon nanotubes in which the content of single dispersed single-walled carbon nanotubes is not lower than 50 wt %, preferably 50 wt %-60 wt %, wherein, the single-walled carbon nanotubes can be dispersed in the solvent, and the surfactant and dispersant can be dissolved in the solvent;
(2) employing density gradient centrifugation to sort the highly dispersed single-walled carbon nanotubes obtained in step (1).

The inventor of the present invention has found: when the single-walled carbon nanotubes contacts with a surfactant and a dispersant sequentially in the present of a solvent, the single-walled carbon nanotubes can be dispersed well in the surfactant and dispersant, and a system with high content of single dispersed single-walled carbon nanotubes can be obtained. The reason may be: when single-walled carbon nanotubes contact with the surfactant, single-walled carbon nanotube bundles that are dispersed stably in the surfactant can be obtained; then, when the single-walled carbon nanotube bundles contact with the dispersant, the dispersant and the single-walled carbon nanotube bundles interact with each other, so that the dispersant can enter into the single-walled carbon nanotube bundles easily, split the tube bundles effectively and decrease the proportion of aggregated single-walled carbon nanotubes; thus, a highly dispersed single-walled carbon nanotube system is obtained. Moreover, the successful preparation of the highly dispersed single-walled carbon nanotube system provides possibility for further obtaining single-walled carbon nanotubes with different structural properties.

According to a preferred embodiment of the present invention, single-walled carbon nanotubes with different structural properties can be separated effectively if the density gradient centrifugation for separating highly dispersed single-walled carbon nanotubes comprises: employing a first stage of density gradient centrifugation to sort the highly dispersed single-walled carbon nanotubes, so as to separate the single-walled carbon nanotubes into layers by tube diameter and aggregation state; and then employing a second stage of density gradient centrifugation to sort the obtained different single-walled carbon nanotube layers, so as to separate the single-walled carbon nanotubes obtained in the first stage of density gradient centrifugation into layers by length. According to another preferred embodiment of the present invention, single-walled carbon nanotubes with different structural properties can be separated more effectively if the density gradient reagents used in the two stages of density gradient centrifugation are an iodixanol-containing solution and the concentrations of the density gradient reagent from top to bottom are 8-12 wt %, 15-35 wt %, and 55-65 wt %.

Other characteristics and advantages of the present invention will be further detailed in the embodiments hereunder.

### BRIEF DESCRIPTION OF THE DRAWINGS

The drawings are provided here to facilitate further understanding on the present invention, and are a part of the description. They are used in conjunction with the following embodiments to explain the present invention, but shall not be comprehended as constituting any limitation to the present invention. Among the drawings:

FIG. 1 is a schematic diagram of a first stage of density gradient centrifugation, wherein, FIG. 1(A) is a schematic diagram of a first stage of density gradient centrifugation, and FIG. 1(B) is an effect drawing of a first stage of density gradient centrifugation;

FIG. 2 shows the results of near infrared photoluminescence spectra of the four fractions obtained in example 1;

FIG. 3 shows the result of Atomic Force Microscope (AFM) images and length distribution of the four fractions obtained in example 1;

FIG. 4 shows the AFM images and length distribution of different fractions obtained after allowing fractions A and C in example 1 to undergo a second stage of density gradient centrifugation.

### DETAILED DESCRIPTION

Hereunder the embodiments of the present invention will be detailed. It should be appreciated that the embodiments described here are only provided to describe and explain the present invention, but shall not be deemed as constituting any limitation to the present invention.

The method for treating single-walled carbon nanotubes provided in the present invention comprises the following steps:
(1) allowing single-walled carbon nanotubes to contact with a surfactant and a dispersant sequentially in the present of a solvent, to obtain highly dispersed single-walled carbon nanotubes in which the content of single dispersed single-walled carbon nanotubes is not lower than 50 wt %, preferably 50 wt %-60 wt %, wherein, the single-walled carbon nanotubes can be dispersed in the solvent, and the surfactant and dispersant can be dissolved in the solvent;
(2) employing density gradient centrifugation to sort the highly dispersed single-walled carbon nanotubes obtained in step (1).

Wherein, the single-walled carbon nanotubes can exist in the form of powder, and in this case, said allowing single-walled carbon nanotubes to contact with a surfactant and dispersant in the present of a solvent comprises: allowing the single-walled carbon nanotubes to contact with a surfactant solution and a dispersant solution sequentially;

alternatively, the single-walled carbon nanotubes can exist in the form of a dispersion liquid, in which the content of single dispersed single-walled carbon nanotubes is not higher than 10 wt % preferably is 6-8 wt %; in this case, said allowing single-walled carbon nanotubes to contact with a surfactant and dispersant in the present of a solvent comprises: allowing the dispersion liquid of single-walled carbon nanotubes to contact with a surfactant or surfactant solution and a dispersant or dispersant solution sequentially.

According to the present invention, the contents of single dispersed single-walled carbon nanotubes in the single-walled carbon nanotubes that has contacted with the surfactant and dispersant sequentially and in the single-walled carbon nanotubes to be treating can be ascertained with a Scanning Electron Microscope (SEM), or can be calculated from the ratio of the weight of single dispersed single-walled carbon nanotubes obtained by density gradient centrifugation to the total weight of the single-walled carbon nanotubes.

According to the present invention, the single-walled carbon nanotubes to be treating can be purchased commercially, e.g., can be purchased from Chengdu Times Nano Co., Ltd.; or, the single-walled carbon nanotubes to be treating can be prepared with a method known to the person skilled in the art. As described above, the single-walled carbon nanotubes can exist in the form of powder or dispersion liquid; if the single-walled carbon nanotubes exists in the form of dispersion liquid, the weight ratio of single-walled carbon nanotubes to dispersion medium in the dispersion liquid can be 1:1-3, for example; the dispersion medium can be one or more selected from the group consisting of water, ethyl alcohol, methyl alcohol, and acetone.

According to the present invention, the type and dosage of the surfactant can be an ordinary choice in the art. For example, based on 1 g of said single-walled carbon nanotubes, the dosage of the surfactant can be 10-15 g. The surfactant can be one or more selected from the group consisting of sodium cholate, potassium cholate, sodium deoxycholate, potassium deoxycholate, sodium lauryl sulfate, potassium lauryl sulfate, sodium hexadecyl sulfate, potassium hexadecyl sulfate, sodium dodecyl sulfonate, potassium dodecyl sulfonate, sodium hexadecane sulfonate, and potassium hexadecane sulfonate. The surfactant can be used directly or used in the form of solution; if the surfactant is used in the form of solution, the concentration of the surfactant can be 5-10 mg/mL.

There is no specific restriction on the conditions of contact between the single-walled carbon nanotubes and the surfactant in the present invention, as long as the conditions ensure the single-walled carbon nanotubes can be stably dispersed in the surfactant. Usually, the contact conditions include contact temperature and contact time. Usually, higher contact temperature is favorable for dispersion of carbon nanotube powder, but the structure of single-walled carbon nanotubes may be destroyed if the contact temperature is too high. Therefore, the contact temperature is preferably 20-25° C. Longer contact time is helpful for improving the dispersity of the carbon nanotube powder in the surfactant, but excessive long contact time has little contribution to further improvement of the dispersity. Therefore, with comprehensive consideration of effect and efficiency, the contact time is preferably 8-12 h.

According to the present invention, the type and dosage of the dispersant can also be an ordinary choice in the art. For example, based on 1 g of said single-walled carbon nanotubes, the dosage of the dispersant can be 1-2 g. The dispersant can be one or more selected from the group consisting of Rhodamine, fluorescein isothiocyanate, and 1-pyrenebutyric acid. The dispersant can be used directly or used in the form of solution; if the dispersant is used in the form of solution, the concentration of the dispersant can be 200-400 μg/mL. In addition, when both the surfactant and the dispersant are used in the form of solution, to avoid introducing impurities in the separating process of the single-walled carbon nanotubes, preferably the solvent that is used to dissolve the surfactant is of the same type as the solvent that is used to dissolve the dispersant; and the two solvents can be one or more selected from the group consisting of water, ethyl alcohol, methyl alcohol, and acetone. If the carbon nanotubes to be processed exists in the form of dispersion liquid and the surfactant and dispersant exist in the form of solution, preferably the dispersion medium in the carbon nanotube dispersion liquid is of the same type as the solvents used for dissolving the surfactant and dispersant, and can be one or more selected from the group consisting of water, ethyl alcohol, methyl alcohol, and acetone.

There is no specific restriction on the conditions of contact between the dispersant and the product obtained from the contact between the single-walled carbon nanotubes and the surfactant, as long as highly dispersed single-walled carbon nanotubes can be obtained, in which the content of single dispersed single-walled carbon nanotubes is not lower than 50%, preferably is 50-60%; for example, the contact conditions usually include: contact temperature is 2-6° C. and contact time is 12-24 h.

According to the present invention, in step (2), the density gradient centrifugation for separating the highly dispersed single-walled carbon nanotubes can be selected reasonably according to the type of the single-walled carbon nanotubes to be obtained. Preferably, the density gradient centrifugation for separating the highly dispersed single-walled carbon nanotubes comprises: employing a first stage of density gradient centrifugation to sort the highly dispersed single-walled carbon nanotubes, so as to separate the single-walled carbon nanotubes into layers by tube diameter and aggregation state; and then employing a second stage of density gradient centrifugation to sort the obtained different single-walled carbon nanotube layers, so as to separate the single-walled carbon nanotubes obtained in the first stage of density gradient centrifugation into layers by length.

Specifically, after the first stage of density gradient centrifugation of the highly dispersed single-walled carbon nanotubes, single dispersed small-diameter single-walled carbon nanotubes, single dispersed large-diameter single-walled carbon nanotubes, and aggregated single-walled carbon nanotubes can be obtained from top to bottom along the length of centrifuge tube. The aggregated single-walled carbon nanotubes refer to tube bundles formed by 5-15 single-walled carbon nanotubes aggregated together. Moreover, since aggregated single-walled carbon nanotubes at different structural integrity levels are different in density, after the first stage of density gradient centrifugation, the bottommost aggregated carbon nanotubes can be further separated, to obtain single-walled carbon nanotubes in integral structure and single-walled carbon nanotubes in non-integral structure. In other words, after the first stage of density gradient centrifugation, single dispersed small-diameter single-walled carbon nanotubes, single dispersed large-diameter single-walled carbon nanotubes, aggregated single-walled carbon nanotubes in integral structure, and aggregated single-walled carbon nanotubes in non-integral structure can be obtained from top to bottom along the length of centrifuge tube. Then, the obtained different single-walled carbon nanotube layers are separated in a second stage of density gradient centrifugation, i.e., the single dispersed small-diameter single-walled carbon nanotubes, single dispersed large-diameter single-walled carbon nanotubes, and aggregated single-walled carbon nanotubes are separated in a second stage of density gradient centrifugation respectively, to obtain single-walled carbon nanotubes in different lengths. It should be noted: as described above, after the first stage of density gradient centrifugation, the aggregated single-walled carbon nanotubes can be separated into aggregated single-walled carbon nanotubes in integral structure and aggregated single-walled carbon nanotubes in non-integral structure. Therefore, in the second stage of density gradient centrifugation of the aggregated single-walled carbon nanotubes, aggregated single-walled carbon nanotubes in integral structure and aggregated single-walled carbon nanotubes in non-integral structure can be separated in the second stage of density gradient separation respectively, or the mixture of aggregated single-walled carbon nanotubes in integral structure and single-walled carbon nanotubes in non-integral structure can be separated in the second stage of density gradient separation.

In addition, the person skilled in the art should appreciate: if the single-walled carbon nanotubes to be treating have the same diameter and length, after the density gradient centrifugation, the single-walled carbon nanotubes can be separated by aggregation state only to obtain single dispersed single-walled carbon nanotubes and aggregated single-walled carbon nanotubes, and it is known to the person skilled in the art and will not be detailed any more here.

There is no specific restriction on the conditions of the first stage of density gradient centrifugation in the present invention, as long as the conditions ensure that the highly dispersed single-walled carbon nanotubes can be separated into layers by tube diameter and aggregation state. For example, the conditions of the first stage of density gradient centrifugation include: centrifugation speed can be 30000-40000 rpm, centrifugation time can be 8-10 h, the density gradient reagent can be an iodixanol-containing solution, and the concentrations of the density gradient reagent from top to bottom can be 8-12 wt %, 15-35 wt %, and 55-65 wt % respectively. The person skilled in the art should appreciate that the density gradient centrifugation is centrifugation by density carried out in the density gradient reagent, in which different fractions are distributed in the liquid layer that has the same density as the fraction respectively. After density gradient reagents at 55-65 wt %, 15-35 wt, and 8-12 wt % concentrations are added into a centrifuge tube in sequence and highly dispersed single-walled carbon nanotubes are added into the centrifuge tube, the fractions in the highly dispersed single-walled carbon nanotubes will be distributed in different layers owing to density difference; thus, single-walled carbon nanotubes with different structural properties can be separated.

Also, there is no specific restriction on the conditions of the second stage of density gradient centrifugation in the present invention, as long as the conditions ensure that the single-walled carbon nanotube layers obtained in the first stage of density gradient centrifugation can be separated into layers by length respectively. For example, the conditions of the second stage of density gradient centrifugation include: centrifugation speed can be 30000-40000 rpm, centrifugation time can be 8-10 h, the density gradient reagent can be an iodixanol-containing solution, and the concentrations of the density gradient reagent from top to bottom can be 8-12 wt %, 15-35 wt %, and 55-65 wt % respectively.

According to the present invention, to remove impurities in the single-walled carbon nanotubes and improve the water-solubility of the single-walled carbon nanotubes, preferably the method further comprises: allowing the single-walled carbon nanotube to contact with an acidic solution for pretreatment before allowing the single-walled carbon nanotube to contact with the surfactant. The type and dosage of the acidic solution can be an ordinary choice in the art; for example, the acidic solution can be one or more selected from the group consisting of hydrochloric acid, nitric acid aqueous solution, and sulfuric acid aqueous solution; the concentration of the acidic solution can be selected and vary in a wide range, for example, the concentration can be 5-7 mol/L; based on 1 g of single-walled carbon nanotubes, the dosage of the acidic solution can be 1,000-2,000 mL. More preferably, the conditions of contact between the single-walled carbon nanotubes and the acidic solution include: contact temperature is 120-150° C. and contact time is 6-12 h. Furthermore, preferably the product obtained from the contact between the single-walled carbon nanotubes and the acidic solutions can be washed with water to remove residual acidic solution, and then filtered and dried.

Hereunder the present invention will be further detailed in some examples.

In the following examples and comparative examples, the photoluminescent spectrograph is HORIBA Jobin Yvon NanoLog™ purchased from HORIBA; the Atomic Force Microscope (AFM) is Dimension 3100 purchased from Digital Instruments; the Raman spectrometer is Renishaw Micro-Raman Spectroscopy System purchased from Renishaw Plc; the content of single dispersed single-walled carbon nanotubes is measured with Scanning Electron Microscope (SEM) (S-4700 purchased from Hitachi).

### Example 1

This example is provided to describe the method for treating single-walled carbon nanotube provided in the present invention and the single-walled carbon nanotubes obtained.

### (1) Pretreatment of Single-Walled Carbon Nanotubes:

Mix 0.1 g single-walled carbon nanotubes (purchased from Chengdu Times Nano Co., Ltd., in the form of powder) with 150 mL nitric acid aqueous solution which has a concentration of 7 mol/L, allow the mixture to have reflux reaction for 12 h at 120° C., and then filter the mixture, wash the filter residue with water for 3 times, and filter and dry it, to obtained pretreated single-walled carbon nanotube powder;

### (2) Dispersion of Single-Walled Carbon Nanotubes:

At 25° C., mix the product obtained in step (1) with 200 mL sodium lauryl sulfate aqueous solution which has a concentration of 5 mg/mL while stirring for 8 h, cool down the solution to 4° C., add 500 mL Rhodamine 123 aqueous solution which has a concentration of 200 μg/mL and continue to mix and stir for 12 h, to obtain highly dispersed single-walled carbon nanotubes in which the weight ratio of single dispersed single-walled carbon nanotubes to total single-walled carbon nanotubes is 50%;

### (3) Separation by Gradient Centrifugation:

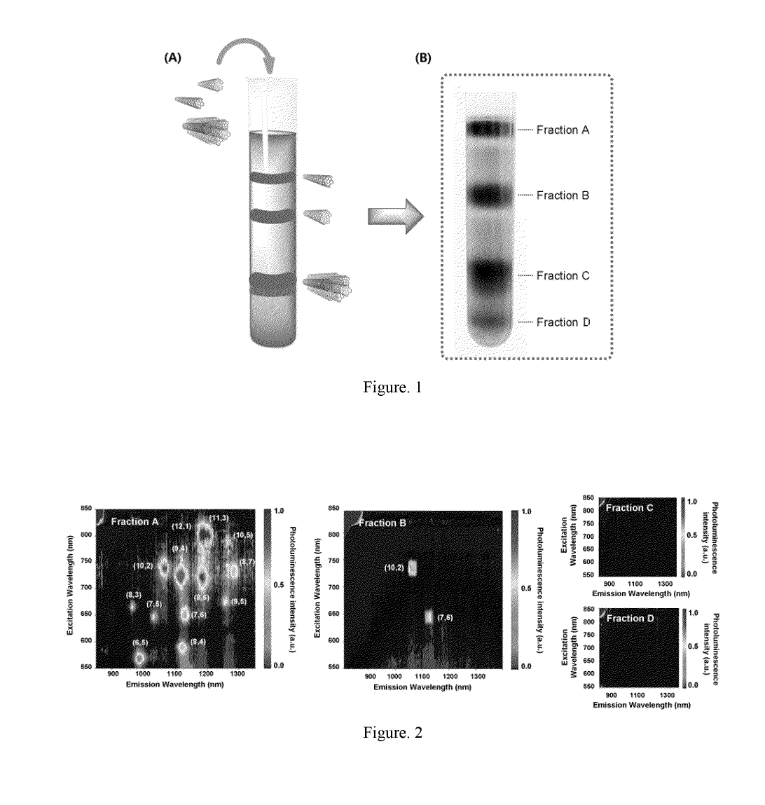

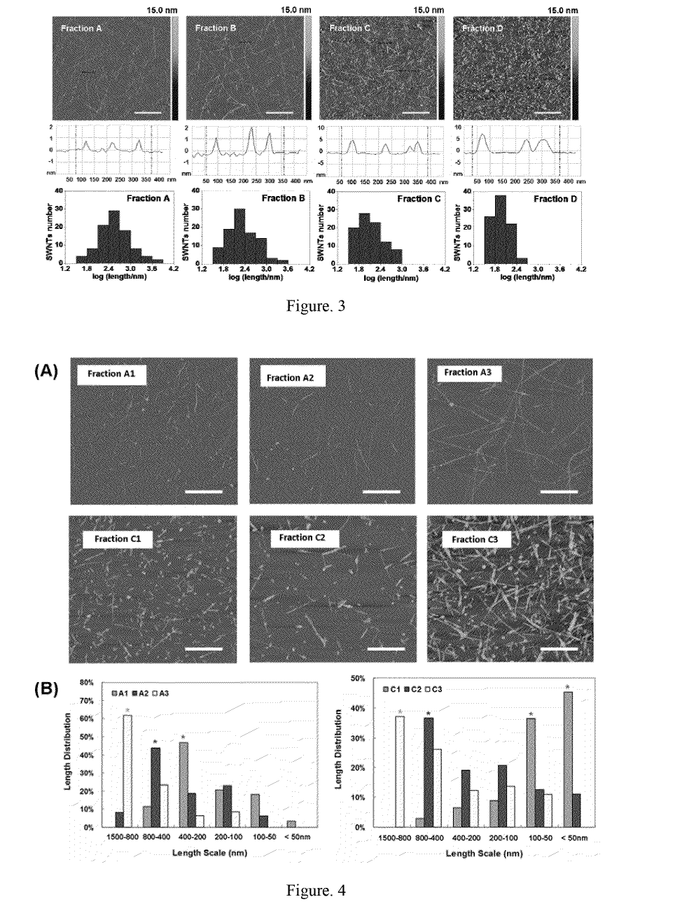

Add 12 mL 60 wt %, 30 wt %, and 10 wt % iodixanol aqueous solutions into a centrifuge tube sequentially, add 1 mL highly dispersed single-walled carbon nanotubes obtained in step (2) into the centrifuge tube, and carry out a first stage of density gradient centrifugation, the conditions of the first stage of density gradient centrifugation include: centrifugation speed is 35000 rpm, and centrifugation time is 9 h; the result is shown in FIG. 1. It is seen from the FIG. 1: after the first stage of gradient centrifugation, four clear strips are obtained. From top to bottom, the four strips are denoted as fraction A, fraction B, fraction C, and fraction D respectively. Carry out structural characterization for the four fractions with photoluminescent spectrograph, AFM, and Raman spectrometer respectively, wherein, the test result of near infrared photoluminescent spectrograph is shown in FIG. 2, and the AFM result is shown in FIG. 3. It is seen from the result in FIG. 2: for fraction A and fraction B, near infrared fluorescent signals can be found, wherein, the chiral configuration of fraction A includes (6,5), (7,5), (7,6), (8,3), (8,4), (8,6), (8,7), (9,4), (9,5), (10,2), (10,5), (11,3), and (12,1); the chiral configuration of fraction B includes (7,6) and (10,2); in contrast, for fraction C and fraction D, no apparent near infrared fluorescent signal is found. That is consistent to the fluorescence quenching mechanism caused by aggregation state. Thus it can be seen that fraction A and fraction B are single dispersed single-walled carbon nanotubes, while fraction C and fraction D are aggregated single-walled carbon nanotubes. It is seen from FIG. 3: the average diameter of fraction A is 0.8 nm, the average diameter of fraction B is 1.5 nm, the average tube bundles section width of fraction C is 4 nm, and the average tube bundles section width of fraction D is 6 nm. It is seen from the structure in Raman spectrum: the structure of fraction C is integral, while the structure of fraction D is non-integral, wherein, fraction C is tube bundles aggregated from 5-10 single-walled carbon nanotubes, and fraction D is tube bundles aggregated from 10-15 single-walled carbon nanotubes. Thus it can be seen: after the first stage of gradient centrifugation, single dispersed small-diameter single-walled carbon nanotubes A, single dispersed large-diameter single-walled carbon nanotubes B, structurally integral aggregated single-walled carbon nanotubes C, and structurally non-integral aggregated single-walled carbon nanotubes D are obtained from top to bottom.
Take four centrifuge tubes, add 12 mL 60 wt %, 30 wt %, and 10 wt % iodixanol aqueous solutions sequentially into each centrifuge tube, and then add 1 mL single dispersed small-diameter single-walled carbon nanotubes A, single dispersed large-diameter single-walled carbon nanotubes B, structurally integral aggregated single-walled carbon nanotubes C, and structurally non-integral aggregated single-walled carbon nanotubes D into the four centrifuge tubes respectively and carry out a second stage of density gradient centrifugation respectively, wherein, the conditions of the second stage of density gradient centrifugation include: centrifugation speed is 36000 rpm, and centrifugation time is 5 h; three different fractions A1, A2, and A3 are obtained from fraction A, wherein, the AFM result indicates that the length range of fraction A1 is 200-400 nm, the length range of fraction A2 is 400-800 nm, and the length of fraction A3 is approximately 1 μm; three different fractions B1, B2, and B3 are obtained from the fraction B, wherein, the AFM result indicates that the length range of fraction B1 is 200-500 nm, the length range of fraction B2 is 500-1,000 nm, and the length of fraction B3 is approximately 1 μm; three different fractions C1, C2, and C3 are obtained from the fraction C, wherein, the AFM result indicates that the length range of fraction C1 is 50-100 nm. the length range of fraction C2 is 200-800 nm, and the length of fraction C3 is approximately 1 μm; three different fractions D1, D2, and D3 are obtained from the fraction D, wherein, the AFM result indicates that the length range of fraction D1 is 50-100 nm, the length range of fraction D2 is 100-500 nm and the length range of fraction D3 is 500 nm-1 μm.

### Example 2

This example is provided to describe the method for treating single-walled carbon nanotube provided in the present invention and the single-walled carbon nanotubes obtained.

### (1) Pretreatment of Single-Walled Carbon Nanotubes:

Mix 0.1 g single-walled carbon nanotubes (purchased from Chengdu Times Nano Co., Ltd., in the form of powder) with 150 mL sulfuric acid aqueous solution which has a concentration of 5 mol/L, allow the mixture to have reflux reaction for 6 h at 150° C., and then filter the mixture, wash the filter residue with water for 3 times, and filter and dry it, to obtained pretreated single-walled carbon nanotube powder;
   (2) Dispersion of single-walled carbon nanotubes:
At 20° C., mix the product obtained in step (1) with 300 mL sodium cholate aqueous solution which has a concentration of 5 mg/mL while stirring for 12 h, cool down the solution to 4° C., add 250 mL fluorescein isothiocyanate aqueous solution which has a concentration of 400 μg/mL and continue to mix and stir for 24 h, to obtain highly dispersed single-walled carbon nanotubes in which the weight ratio of single dispersed single-walled carbon nanotubes to total single-walled carbon nanotubes is 60%;

### (3) Separation by Gradient Centrifugation:

Add 12 mL 55 wt %, 15 wt %, and 8 wt % iodixanol aqueous solutions into a centrifuge tube sequentially, add 1 mL highly dispersed single-walled carbon nanotubes obtained in step (2) into the centrifuge tube, and carry out a first stage of density gradient centrifugation, the conditions of the first stage of density gradient centrifugation include: centrifugation speed is 30000 rpm, and centrifugation time is 10 h. After the first stage of gradient centrifugation, four clear strips are obtained. From top to bottom, the four strips are denoted as fraction A, fraction B, fraction C, and fraction D respectively. Carry out structural characterization for the four fractions with photoluminescent spectrograph, AFM, and Raman spectrometer respectively. It is seen from the result of the photoluminescent spectrograph: for fraction A and fraction B, near infrared fluorescent signals can be found; in contrast, for fraction C and fraction D, no apparent near infrared fluorescent signal is found. That is consistent to the fluorescence quenching mechanism caused by the aggregation state. Thus it can be seen that fraction A and fraction B are single dispersed single-walled carbon nanotubes, while fraction C and fraction D are aggregated single-walled carbon nanotubes. It is seen from the AFM result: the average diameter of fraction A is 0.8 nm, the average diameter of fraction B is 1.5 nm, the average bundles section width of fraction C is 4 nm, and the average bundles section width of fraction D is 6 nm. It is seen from the structure in Raman spectrum: the structure of fraction C is integral, while the structure of fraction D is non-integral, wherein, fraction C is tube bundles aggregated from 5-10 single-walled carbon nanotubes, and fraction D is tube bundles aggregated from 10-15 single-walled carbon nanotubes. Thus it can be seen: after the first stage of gradient centrifugation, single dispersed small-diameter single-walled carbon nanotubes A, single dispersed large-diameter single-walled carbon nanotubes B, structurally integral aggregated single-walled carbon nanotubes C, and structurally non-integral aggregated single-walled carbon nanotubes D are obtained from top to bottom.

Take four centrifuge tubes, add 12 mL 55 wt %, 15 wt %, and 8 wt % iodixanol aqueous solutions sequentially into each centrifuge tube, and then add 1 mL single dispersed small-diameter single-walled carbon nanotubes A, single dispersed large-diameter single-walled carbon nanotubes B, structurally integral aggregated single-walled carbon nanotubes C, and structurally non-integral aggregated single-walled carbon nanotubes D into the four centrifuge tubes respectively and carry out a second stage of density gradient centrifugation respectively, wherein, the conditions of the second stage of density gradient centrifugation include: centrifugation speed is 30000 rpm, and centrifugation time is 6 h; three different fractions A1, A2, and A3 are obtained from fraction A, wherein, the AFM result indicates that the length range of fraction A1 is 200-400 nm, the length range of fraction A2 is 400-800 nm, and the length of fraction A3 is 1 μm; three different fractions B1, B2, and B3 are obtained from the fraction B, wherein, the AFM result indicates that the length range of fraction B1 is 200-500 nm, the length range of fraction B2 is 500-1,000 nm, and the length of fraction B3 is 1 μm; three different fractions C1, C2, and C3 are obtained from the fraction C, wherein, the AFM result indicates that the length range of fraction C1 is 50-100 nm, the length range of fraction C2 is 200-800 nm, and the length of fraction C3 is 1 μm; three different fractions D1, D2, and D3 are obtained from the fraction D, wherein, the AFM result indicates that the length range of fraction D1 is 50-100 nm, the length range of fraction D2 is 100-500 nm, and the length range of fraction D3 is 500 nm-1 nm.

### Example 3

This example is provided to describe the method for treating single-walled carbon nanotube provided in the present invention and the single-walled carbon nanotubes obtained.

### (1) Pretreatment of Single-Walled Carbon Nanotubes:

Mix 0.1 g single-walled carbon nanotubes (purchased from Chengdu Times Nano Co., Ltd., in the form of dispersion liquid, wherein, the dispersion medium of the dispersion liquid is water, and the weight ratio of single-walled carbon nanotubes to water is 1:2, the content of single dispersed single-walled carbon nanotubes in the dispersion liquid is 7 wt %) with 150 mL nitric acid aqueous solution which has a concentration of 6 mol/L, allow the mixture to have reflux reaction for 9 h at 135° C., and then filter the mixture, wash the filter residue with water for 3 times, and filter and dry it, to obtained pretreated single-walled carbon nanotube powder;

### (2) Dispersion of Single-Walled Carbon Nanotubes:

At 22° C. mix the product obtained in step (1) with 150 mL sodium deoxycholate aqueous solution which has a concentration of 8 mg/mL while stirring for 10 h, cool down the solution to 4° C., add 350 mL 1-pyrenebutyric acid aqueous solution which has a concentration of 300 μg/mL and continue to mix and stir for 20 h, to obtain highly dispersed single-walled carbon nanotubes in which the weight ratio of single dispersed single-walled carbon nanotubes to total single-walled carbon nanotubes is 55%;

### (3) Separation by Gradient Centrifugation:

Add 12 mL 65 wt %, 35 wt %, and 12 wt % iodixanol aqueous solutions into a centrifuge tube sequentially, add 1 mL highly dispersed single-walled carbon nanotubes obtained in step (2) into the centrifuge tube, and carry out a first stage of density gradient centrifugation, the conditions of the first stage of density gradient centrifugation include: centrifugation speed is 40000 rpm and centrifugation time is 8 h. After the first stage of gradient centrifugation, four clear strips are obtained. From top to bottom, the four strips are denoted as fraction A, fraction B, fraction C, and fraction D respectively. Carry out structural characterization for the four fractions with photoluminescent spectrograph, AFM, and Raman spectrometer respectively. It is seen from the test result of the photoluminescent spectrograph: for fraction A and fraction B, near infrared fluorescent signals can be found; in contrast, for fraction C and fraction D, no apparent near infrared fluorescent signal is found. That is consistent to the fluorescence quenching mechanism caused by the aggregation state. Thus it can be seen that fraction A and fraction B are single dispersed single-walled carbon nanotubes, while fraction C and fraction D are aggregated single-walled carbon nanotubes. It is seen from the AFM result: the average diameter of fraction A is 0.8 nm, the average diameter of fraction B is 1.5 nm, the average bundles section width of fraction C is 3 nm, and the average bundles section width of fraction D is 7 nm. It is seen from the structure in Raman spectrum: the structure of fraction C is integral, while the structure of fraction D is non-integral, wherein, fraction C is tube bundles aggregated from 5-10 single-walled carbon nanotubes, and fraction D is tube bundles aggregated from 10-15 single-walled carbon nanotubes. Thus it can be seen: after the first stage of gradient centrifugation, single dispersed small-diameter single-walled carbon nanotubes A, single dispersed large-diameter single-walled carbon nanotubes B, structurally integral aggregated single-walled carbon nanotubes C, and structurally non-integral aggregated single-walled carbon nanotubes D are obtained from top to bottom.
Take four centrifuge tubes, add 12 mL 65 wt %, 35 wt %, and 12 wt % iodixanol aqueous solutions sequentially into each centrifuge tube, and then add 1 mL single dispersed small-diameter single-walled carbon nanotubes A, single dispersed large-diameter single-walled carbon nanotubes B, structurally integral aggregated single-walled carbon nanotubes C, and structurally non-integral aggregated single-walled carbon nanotubes D into the four centrifuge tubes respectively and carry out a second stage of density gradient centrifugation respectively, wherein, the conditions of the second stage of density gradient centrifugation include: centrifugation speed is 40000 rpm, and centrifugation time is 6 h; three different fractions A1, A2, and A3 are obtained from fraction A, wherein, the AFM result indicates that the length range of fraction A1 is 200-400 nm, the length range of fraction A2 is 400-800 nm, and the length of fraction A3 is approximately 1 μm; three different fractions B1, B2, and B3 are obtained from the fraction B, wherein, the AFM result indicates that the length range of fraction B1 is 200-500 nm, the length range of fraction B2 is 500-1,000 nm, and the length of fraction B3 is approximately 1 μm; three different fractions C1, C2, and C3 are obtained from the fraction C, wherein, the AFM result indicates that the length range of fraction C1 is 50-100 nm. the length range of fraction C2 is 200-800 nm, and the length of fraction C3 is approximately 1 μm; three different fractions D1, D2, and D3 are obtained from the fraction D, wherein, the AFM result indicates that the length range of fraction D1 is 50-100 nm, the length range of fraction D2 is 100-500 nm and the length range of fraction D3 is 500 nm-1 μm.

### Example 4

This example is provided to describe the method for treating single-walled carbon nanotube provided in the present invention and the single-walled carbon nanotubes obtained.

Separate the single-walled carbon nanotubes with the method described in example 1, but the method in this example does not comprise the pretreatment step of the single-walled carbon nanotube. After the first stage of density gradient centrifugation, single dispersed small-diameter single-walled carbon nanotubes A, single dispersed large-diameter single-walled carbon nanotubes B, structurally integral aggregated single-walled carbon nanotubes C, and structurally non-integral aggregated single-walled carbon nanotubes D are obtained from top to bottom. After the second stage of density gradient centrifugation, three different fractions A1, A2, and A3 are obtained from fraction A, wherein, the AFM result indicates that the length range of fraction A1 is 200-400 nm, the length range of fraction A2 is 400-800 nm, and the length range of fraction A3 is 1 μm; three different fractions B1, B2, and B3 are obtained from fraction B, wherein, the AFM result indicates that the length range of fraction B1 is 200-500 nm, the length range of fraction B2 is 500-1,000 nm, and the length range of fraction B3 is 1 μm; three different fractions C1, C2, and C3 are obtained from fraction C, wherein, the AFM result indicates that the length range of fraction C1 is 50-100 nm, the length range of fraction C2 is 200-800 nm, and the length range of fraction C3 is 1 μm; three different fractions D1, D2, and D3 are obtained from fraction D, wherein, the AFM result indicates that the length range of fraction D1 is 50-100 nm, the length range of fraction D2 is 100-500 nm, and the length range of fraction D3 is 500 nm-1 μm.

### Comparative Example 1

This comparative example is provided to describe a comparative method for treating single-walled carbon nanotubes and the single-walled carbon nanotubes obtained.

Separate the single-walled carbon nanotubes with the method described in example 1, but replace the Rhodamine 123 aqueous solution with sodium lauryl sulfate aqueous solution at the same concentration and volume in the dispersion step of single-walled carbon nanotube. The result indicates that there is no apparent improvement in the dispersity of the single-walled carbon nanotube solution system, wherein, the content of aggregated single-walled carbon nanotubes is approximately 90%.

### Comparative Example 2

This comparative example is provided to describe a comparative method for treating single-walled carbon nanotubes and the single-walled carbon nanotubes obtained.

Separate the single-walled carbon nanotubes with the method described in example 1, but replace the sodium lauryl sulfate aqueous solution with Rhodamine 123 aqueous solution at the same concentration and volume in the dispersion step of single-walled carbon nanotube. The result indicates that the water-solubility of the single-walled carbon nanotube solution system is very low, and a large quantity of single-walled carbon nanotubes precipitates out in the form of precipitate.

It can be seen from the above results: by using the method provided in the present invention, single-walled carbon nanotubes with different structural properties can be separate effectively, and thereby a foundation is set for subsequent system study for single-walled carbon nanotubes with ti different structural properties.

While some preferred embodiments of the present invention are described above, the present invention is not limited to the details in those embodiments. The person skilled in the art can make modifications and variations to the technical scheme of the present invention, without departing from the spirit of the present invention. However, all these modifications and variations shall be deemed as falling into the protected scope of the present invention.

In addition, it should be noted: the specific technical features described in above embodiments can be combined in any appropriate form, provided that there is no conflict. To avoid unnecessary repetition, the possible combinations are not described specifically in the present invention.

Moreover, different embodiments of the present invention can be combined freely as required, as long as the combinations don't deviate from the ideal and spirit of the present invention. However, such combinations shall also be deemed as falling into the scope disclosed in the present invention.

1.-11. (canceled)

12. A method for treating single-walled carbon nanotubes, comprising: a) contacting single-walled carbon nanotubes with a surfactant and a dispersant sequentially in the presence of a solvent to obtain highly dispersed single-walled carbon nanotubes, wherein the content of single dispersed single-walled carbon nanotubes within said highly dispersed single-walled carbon nanotubes is not lower than 50 wt. %, wherein, the single-walled carbon nanotubes can be dispersed in the solvent, and the surfactant and dispersant can be dissolved in the solvent; and b) employing density gradient centrifugation to sort said highly dispersed single-walled carbon nanotubes.

13. The method according to claim 12, wherein the content of single dispersed single-walled carbon nanotubes in the highly dispersed single-walled carbon nanotubes is 50 wt. % to 60 wt. %.

14. The method according to claim 12, wherein the single-walled carbon nanotubes exist in the form of powder.

15. The method according to claim 12, wherein the single-walled carbon nanotubes exist in the form of a dispersion liquid.

16. The method according to claim 15, wherein the content of the single dispersed single-walled carbon nanotubes is not higher than 10 wt. %.

17. The method according to claim 15, wherein the content of single dispersed single-walled carbon nanotubes is 6 wt. % to 8 wt. %.

18. The method according to claim 12, wherein 10 g to 15 g of the surfactant is included for every 1 g of said single-walled carbon nanotubes.

19. The method according to claim 12, wherein the surfactant is selected from the group consisting of sodium cholate, potassium cholate, sodium deoxycholate, potassium deoxycholate, sodium lauryl sulfate, potassium lauryl sulfate, sodium hexadecyl sulfate, potassium hexadecyl sulfate, sodium dodecyl sulfonate, potassium dodecyl sulfonate, sodium hexadecane sulfonate, potassium hexadecant sulfonate, and mixtures thereof.

20. The method according to claim 12, wherein the single-walled carbon nanotubes are contacted with the surfactant at a contact temperature of 20° C. to 25° C. for 8 hours to 12 hours.

21. The method according to claim 12, wherein 1 g to 2 g of the dispersant is included for every 1 g of said single-walled carbon nanotubes.

22. The method according to claim 12, wherein the dispersant is selected from the group consisting of Rhodamine, fluorescein isothiocyanate, 1-pyrenebutyric acid, and mixtures thereof.

23. The method according to claim 12, wherein product obtained from the contact between the single-walled carbon nanotubes and the surfactant and the dispersant are contacted at a contact temperature of 2° C. to 6° C. for 12 hours to 24 hours.

24. The method according to claim 12, wherein employing density gradient centrifugation to sort said highly dispersed single-walled carbon nanotubes further comprises: employing a first stage of density gradient centrifugation and a second stage of density gradient centrifugation.

25. The method according to claim 24, wherein the first stage of density gradient centrifugation sorts the single-walled carbon nanotubes into layers by tube diameter and aggregation state.

26. The method according to claim 24, wherein the second stage of density gradient centrifugation sorts the single-walled carbon nanotubes obtained in the first stage of density gradient centrifugation into layers by length.

27. The method according to claim 25, wherein centrifugation speed is 30000-40000 rpm, centrifugation time is 8 hours to 10 hours, density gradient reagent is an iodixanol-containing solution, and concentrations of the density gradient reagent are 8 wt. % to 12 wt. %, 15 wt. % to 35 wt. %, and 55 wt. % to 65 wt. % from top to bottom.

28. The method according to claim 26, wherein centrifugation speed is 30000-40000 rpm, centrifugation time is 4 hours to 6 hours, density gradient reagent is an iodixanol-containing solution, and concentrations of the density gradient reagent are 8 wt. % to 12 wt. %, 15 wt. % to 35 wt. %, and 55 wt. % to 65 wt. % from top to bottom.

29. The method according to claim 12, further comprising contacting the single-walled carbon nanotubes with an acidic solution for pretreatment before the single-walled carbon nanotubes contact with the surfactant.

30. The method according to claim 29, wherein the single-walled carbon nanotubes are contacted with the acidic solution at a temperature of 120° C. to 150° C. for 6 hours to 12 hours.

31. The method according to claim 24, further comprising pretreating the single-walled carbon nanotubes with an acidic solution before the single-walled carbon nanotubes contact with the surfactant, said pretreating at a temperature of 120° C. to 150° C. for 6 hours to 12 hours.
